(19) United States
(12) Patent Application Publication
(10) Pub. No.: US 2006/0114265 A1
(43) Pub. Date: Jun. 1, 2006

(54) Display control device and display control method

(76) Inventor: Yoichi Nishida, Kasuya-Gun (JP)

Correspondence Address: WENDEROTH, LIND & PONACK L.L.P., 2033 K. STREET, NW, SUITE 800, WASHINGTON, DC, 20006, US

(21) Appl. No.: 11/251,894

(22) Filed: Oct. 18, 2005

(30) Foreign Application Priority Data
Nov. 26, 2004 (JP) 2004-342086

(51) Int. Cl. G09G 5/02

(52) U.S. Cl. 345/593

(57) ABSTRACT

A display control device comprises a first calculating unit calculating a first characteristic amount that indicates a characteristic of a first image, an image adjusting unit adjusting a second image and generating an adjusted second image based on the first characteristic amount, a generating unit generating a display image that is displayed in a display unit by composing the first image and the adjusted second image, a second calculating unit calculating a second characteristic amount that shows a characteristic of the display image, and a display adjusting unit adjusting the display of the display image in the display unit based on the second characteristic amount.

### BACKGROUND OF THE INVENTION

1. Field of the Invention

The present invention relates to a display control device and a display control method adjusting appropriately luminance and chrominance of an image to be displayed, in displaying the image in a display device, especially in such a display device that displays an image by irradiation from a light source.

2. Description of the Related Art

Many of cellular phones and portable information terminals in recent years comprise a display unit such as a liquid crystal display and an organic electroluminescence (EL) panel, which displays images and data acquired through streaming distribution. With increased prevalence of data communication including an electronic mail, a display image that a distributed natural image is composed of a graphics image for data display is often displayed on the display unit. For example, a display image in a TV phone is a composition of the person image with letter and figure images as a framework.

Accordingly, the display image often consists of a composition of a natural image with letters and figures, with a demand for high definition display of images including these letters and figures. In order to meet this demand, adjustment of the luminance and chrominance of the display image is performed. A liquid crystal panel equipped with a light source such as a back light is used for a display unit of portable information terminals in many cases. In the liquid crystal panel, the luminance of the display image displayed can be adjusted through adjustment of transmittivity of the liquid crystal panel or adjustment of light intensity of the light source.

On the other hand, since these cellular phones and portable information terminals are driven with batteries, reduction of power consumption is required. Accordingly, the luminance of the display image is adjusted for the display device to operate at small power consumption by related adjustment of the transmittivity of the liquid crystal panel and the light intensity of the light source.

Document 1 (published Japanese Patent Application Laid-Open No. H01-239589) discloses an art that detects a maximum value in display signal of a display image, and adjusts simultaneously transmittivity of a liquid crystal panel and light intensity of a light source based on the detected maximum value. The luminance adjustment of the display image is realized so that power consumption becomes small, by the art disclosed in Document 1.

However, the prior art has the following problems.

According to the art disclosed in Document 1, the maximum value of the image signal is detected from the display image itself which consists of a composed image of a natural image and a graphics image.

It is common for the graphics image to be high in luminance, whereas it is common for the natural image to be low in luminance.

The art disclosed in Document 1 detects a maximum value of the image signal of the display image; however, the detected maximum value is greatly influenced by the graphics image with high luminance, leading to unfavorable detection of an extremely large maximum value. Compared to the natural image with large variation of the luminance per frame, the graphics image provides small variation of the luminance, since the graphics image is artificially created as letters and figures. Accordingly, the maximum value of the image signal of the display image becomes large, as a result of great influence by the luminance of the graphics image.

For the reason mentioned above, there is a problem that a margin for the luminance adjustment of the display image is narrowed, resulting in insufficient adjustment of the display image. Because of the narrow adjustment margin, there is also a problem that a high definition display is difficult especially in the graphics area with high luminance.

There is another problem that variation of the luminance of the natural image is hard to be reflected in the maximum value of the image signal, therefore luminance difference between the natural image and the graphics image becomes large and the luminance adjustment of the display becomes hard to be effective.

In addition, there is a problem that adjustment of the display image to unnecessarily high luminance is performed because the maximum value of the image signal is large, and hence it becomes necessary to increase light intensity of the light source, leading to increased power consumption.

### OBJECTS AND SUMMARY OF THE INVENTION

An object of the present invention is to provide a display control device and a display control method that can generate a display image after reflecting a characteristic of a natural image in adjusting a graphics image, and adjust appropriately both the natural image area and the graphics image area; thereby providing the display control device and the display control method with high efficiency in power consumption.

A first aspect of the present invention provides a display control device comprising: a first calculating unit operable to calculate a first characteristic amount characterizing a first image; an image adjusting unit operable to adjust a second image according to the first characteristic amount, thereby generating an adjusted second image; a generating unit operable to generate a display image to be displayed on a display unit, by composing the first image and the adjusted second image; a second calculating unit operable to calculate a second characteristic amount characterizing the display image; and a display adjusting unit operable to adjust, according to the second characteristic amount, appearance of the display image displayed on the display unit.

With the present structure, the second image that is mainly composed of a graphics image with high luminance is adjusted with respect to the luminance and chrominance thereof by the first image that is mainly composed of a natural image. Since the luminance of the display image to be generated is matched to that of the first image, an adjustment margin is large and the display image displayed eventually is adjusted appropriately.

A second aspect of the present invention provides the display control device as claimed in the first aspect, wherein the first image is a natural image and the second image is a graphics image.

With the present structure, an artificially generated graphics image is adjusted by a characteristic such as naturally appearing luminance and chrominance that the natural image has.

A third aspect of the present invention provides the display control device as claimed in the first aspect, wherein the first calculating unit calculates, as the first characteristic amount, at least one of luminance and chrominance of the first image.

With the present structure, a suitable characteristic amount is calculated from the first image.

A fourth aspect of the present invention provides the display control device as claimed in the first aspect, wherein the image adjusting unit adjusts at least one of luminance and chrominance of the second image.

With the present structure, the second image is adjusted corresponding to the first image.

A fifth aspect of the present invention provides the display control device as claimed in the first aspect, wherein the image adjusting unit further comprises: a limiting unit operable to limit an adjustment amount in adjusting the second image.

With the present structure, an extreme variation of luminance and chrominance per frame is suppressed, and a display screen that is gentle to eyes is generated.

A sixth aspect of the present invention provides the display control device as claimed in the fifth aspect, wherein the limiting unit limits the adjustment amount to a certain greatest amount.

With the present structure, an extreme variation of luminance and chrominance per frame is suppressed, and a display screen that is gentle to eyes is generated.

A seventh aspect of the present invention provides the display control device as claimed in the fifth aspect, wherein the limiting unit limits the adjustment amount for a present picture frame which is an adjusting target for the image adjusting unit, in such a manner that a difference between the adjustment amount for the present picture frame and an adjustment amount for a picture frame previous to the present picture frame is less than a predetermined amount.

With the present structure, an extreme variation of luminance and chrominance per frame is suppressed, and a display screen that is gentle to eyes is generated.

An eighth aspect of the present invention provides the display control device as claimed in the first aspect, wherein the second calculating unit calculates at least one of luminance and chrominance of the display image.

With the present structure, the display image is appropriately adjusted.

A ninth aspect of the present invention provides the display control device as claimed in the first aspect, wherein the second calculating unit calculates the second characteristic amount from a partial area arbitrarily chosen in the display image.

With the present structure, calculation of the characteristic amount from the display image is performed on the basis of a natural image.

A tenth aspect of the present invention provides the display control device as claimed in the ninth aspect, wherein the partial area is an area where the second image does not exist in the display image.

With the present structure, calculation of the characteristic amount from the display image is performed on the basis of a natural image.

An eleventh aspect of the present invention provides the display control device as claimed in the first aspect, wherein the display adjusting unit adjusts a display screen and a light source, keeping relationship therebetween. The display screen and the light source are included in the display unit.

With the present structure, the display of a display image is adjusted so that power consumption becomes small.

A twelfth aspect of the present invention provides the display control device as claimed in the eleventh aspect, wherein the display adjusting unit adjusts luminance of the display image displayed on the display screen and luminance of the light source, keeping the relationship between the luminance of the display image and the luminance of the light source.

With the present structure, the display of a display image is adjusted so that power consumption becomes small.

A thirteenth aspect of the present invention provides the display control device as claimed in the eleventh aspect, wherein the display screen is a liquid crystal panel, and the display adjusting unit adjusts transmittivity of the liquid crystal panel and the luminance of the light source.

With the present structure, the display of a display image is adjusted so that power consumption becomes small.

A fourteenth aspect of the present invention provides the display control device as claimed in the first aspect, wherein the first calculating unit and the second calculating unit use a common calculating unit in a time-sharing manner.

With the present structure, a circuit scale can be reduced.

A fifteenth aspect of the present invention provides a display control device comprising: a generating unit operable to generate a display image to be displayed on a display unit, by composing a first image and an adjusted second image; a calculating unit operable to calculate a first characteristic amount characterizing the first image and a second characteristic amount characterizing the display image; an image adjusting unit operable to adjust a second image according to the first characteristic amount, thereby generating the adjusted second image; and a display adjusting unit operable to adjust, according to the second characteristic amount, appearance of the display image displayed on the display unit.

With the present structure, a circuit scale can be reduced; in addition, the display image is appropriately adjusted.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a display control device according to Embodiment 1 of the present invention;

FIG. 2 is a block diagram illustrating the display control device according to Embodiment 1 of the present invention;

FIG. 3 is an illustration showing a display image according to Embodiment 1 of the present invention;

FIG. 4 is a block diagram illustrating the display control device according to Embodiment 1 of the present invention;

FIG. 5 is a block diagram illustrating the display control device according to Embodiment 1 of the present invention;

FIG. 6 is a block diagram illustrating the display control device according to Embodiment 1 of the present invention;

FIG. 7 is a block diagram illustrating a display control device according to Embodiment 2 of the present invention; and

FIG. 8 is a block diagram illustrating the display control device according to Embodiment 2 of the present invention.

### DETAILED DESCRIPTION OF THE PREFERRED EMBODIMENTS

Hereinafter, embodiments of the present invention are explained with reference to the following drawings.

### Embodiment 1

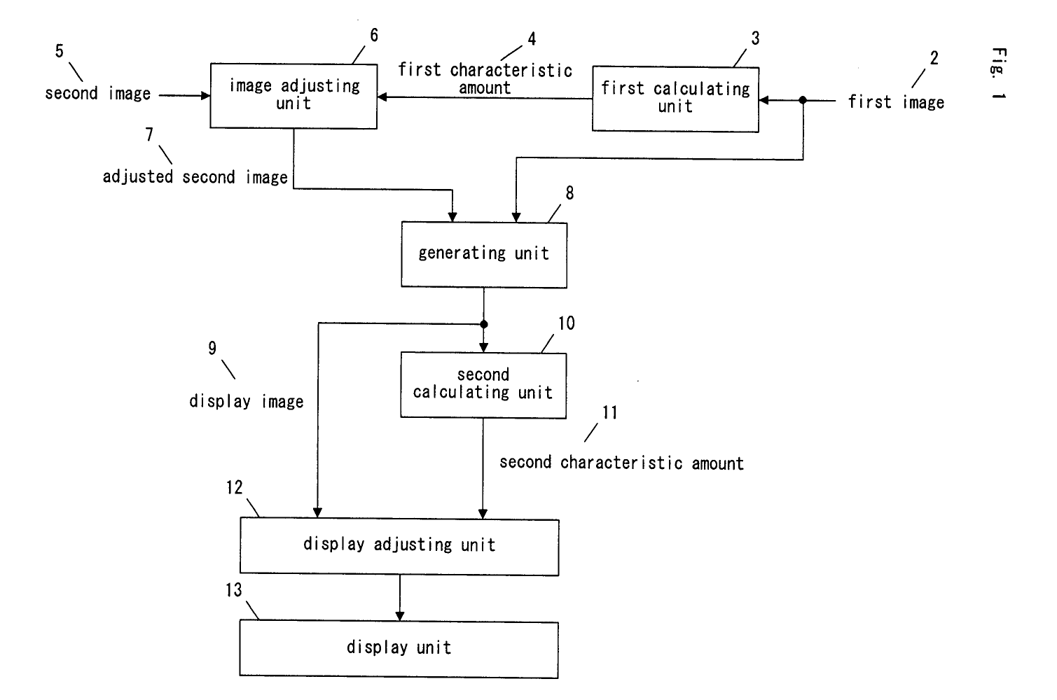

FIG. 1 is a block diagram illustrating a display control device according to Embodiment 1 of the present invention.

A display control device 1 comprises the following elements. A first calculating unit 3 calculates a first characteristic amount 4 that indicates a characteristic of a first image 2. An image adjusting unit 6 adjusts a second image 5 based on the first characteristic amount 4, and generates an adjusted second image 7. A generating unit 8 composes the first image 2 and the adjusted second image 7, and generates a display image 9 to be displayed in a display unit 13. A second calculating unit 10 calculates a second characteristic amount 11 that indicates a characteristic of the display image 9. A display adjusting unit 12 adjusts the display of the display image 9 to be displayed in the display unit 13, based on the second characteristic amount 11.

The details of each unit are explained.

First, the first calculating unit 3 is explained.

The first calculating unit 3 calculates the first characteristic amount 4 that indicates the characteristic of the first image 2. Here, it is assumed that the first image 2 is mainly composed of a natural image of which luminance and chrominance change naturally.

The first calculating unit 3 calculates various parameters that indicate the characteristic of the first image 2 as the first characteristic amount 4. For example, the first calculating unit 3 calculates, mainly in frame units, the average value and the maximum value of the luminance of the first image and those of the chrominance of the first image, as the first characteristic amount 4. The maximum value of the luminance is calculated in pixel units. If the first image is of RGB (Red, Green, and Blue) data, the average value and the maximum value of each component of R, G and B may be calculated as the first characteristic amount 4.

Although the first calculating unit 3 calculates the first characteristic amount 4 from one frame of the first image 2 in the present embodiment, the first characteristic amount 4 may be calculated from several frames, and the first characteristic amount 4 may be alternatively calculated from a part of one frame.

Here, the first characteristic amount 4 is calculated from the first image 2 that is mainly composed of a natural image, because the first image 2 occupies most of natural impressions that the generated display image 9 gives to visual sensation.

Next, the image adjusting unit 6 is explained.

The image adjusting unit 6 adjusts the second image 5 based on the first characteristic amount 4. Here, the second image 5 is often a graphics image that is made artificially, such as letters and figures. Such a graphics image is constituted by bright monochrome and primary colors, and the luminance is often high. On the other hand, the first image 2, which is mainly a natural image, includes a background, a person, etc., and the luminance is often low. Furthermore, the luminance of the first image 2 changes greatly as scenes change. On the contrary, changes in the luminance of the second image 5 are small. Accordingly, when the first image 2 and the second image 5 are composed as they are to generate the display image 9, unbalanced display images are often obtained, since a graphics image including letter information with extremely high luminance is superimposed on the screen with low luminance.

The image adjusting unit 6 reduces the differences of the luminance and chrominance between the first image 2 and the second image 5 by adjusting the second image 5 in terms of the first characteristic amount 4 that is calculated from the luminance and chrominance.

For example, the image adjusting unit 6 matches the maximum luminance of the second image 5 with the maximum luminance of the first image 2 included in the first characteristic amount 4. Thereby, the difference of the luminance between the first image 2 and the second image 5 decreases. Of course, the image adjusting unit 6 may adjust the second image 5 not only by luminance but also by the chrominance, RGB components or others. It is desirable that the second image 5 is adjusted by a parameter that corresponds to the parameter included in the first characteristic amount 4.

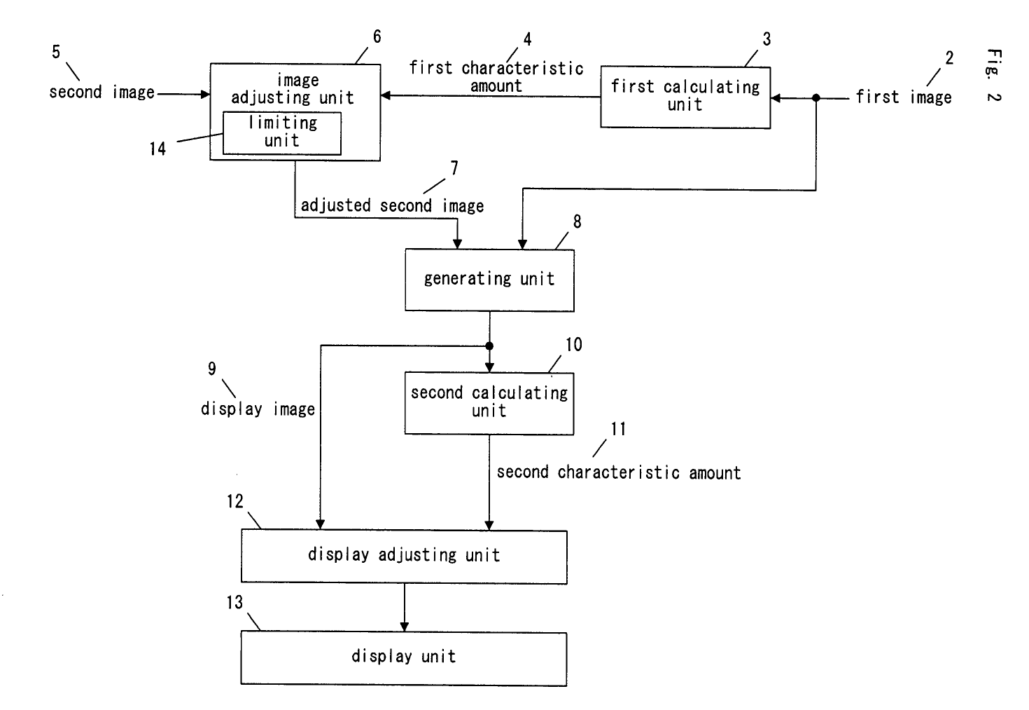

Here, the image adjusting unit 6 may further comprise a limiting unit 14 that limits adjustment amount used in adjusting the second image 5. FIG. 2 is a block diagram of the display control device in Embodiment 1 of the present invention, illustrating a structure that the image adjusting unit 6 comprises the limiting unit 14.

The first characteristic amount 4 indicating the luminance of the first image 2 adjusts the second image 5 that is constituted by a graphics image. At this time, the change of the luminance and chrominance, etc. of the first image 2 may be large in frame units. Accordingly, such a situation occurs where the adjustment amount of the luminance, chrominance, etc. is large in a certain frame of the second image 5, and the adjustment amount in the next frame is small. In the situation, the luminance change of the display image 9 finally displayed on the display unit 13 becomes intense, causing halation. Moreover, the image appears unpleasant for a viewer.

To prevent such a situation from occurring, the limiting unit 14 limits the magnitude of the adjustment amount to the second image 5, and controls such over-performed change by adjustment, as follows.

(Processing 1) The limiting unit 14 defines and limits the maximum value of the adjustment amount in each frame of the second image 5.

(Processing 2) The limiting unit 14 limits the difference in the adjustment amount between the present frame and the previous frame to below the predetermined amount.

In the Processing 1, the limiting unit 14 controls the adjustment amount to be below the predetermined maximum value, and notifies the image adjusting unit 6 of the limited adjustment amount. The image adjusting unit 6 adjusts the second image 5 according to the limited adjustment amount.

In the Processing 2, the magnitude of the adjustment amount to the second image 5 is limited based on the difference. For example, when the first characteristic amount 4 includes the luminance and the image adjusting unit 6 adjusts the luminance of the second image 5, it is assumed that the value for the adjustment amount of luminance in an arbitrary frame of the second image 5 is “10”. When the value for the adjustment amount of luminance in the next frame following the arbitrary frame is increased to “100”, the difference value is “90”. When the limiting unit 14 limits the difference value to below “50” that is a value of the predetermined amount, the adjustment amount to the next frame is limited to “60”, which comes from adding the value of “50” to the value of “10” for the adjustment amount of the previous frame. In other words, the limiting unit 14 limits the value of “90” for the original adjustment amount calculated by the first characteristic amount 4 to the value of “60”.

The image adjusting unit 6 adjusts the luminance of the second image 5 using the adjustment amount based on the value of “60” that is limited by the limiting unit 14. Even for parameters such as chrominance other than luminance, similar limiting process can be performed.

As mentioned above, since the adjustment amount used in the image adjusting unit 13 is appropriately limited according to necessity, the final display image 9 displayed on the display unit 13 appears more pleasant for viewers.

In the present embodiment, the limiting unit 14 is included in the image adjusting unit 6 in FIG. 2; however, the limiting unit 14 may be separately set up as an independent unit. Moreover, the image adjusting unit 6 outputs the adjusted second image 7 after adjusting the second image 5.

The image adjusting unit 6 may adjust the luminance and chrominance of the generated second image 5, based on the first characteristic amount 4, in an ex post facto manner. Alternatively, the image adjusting unit 6 may generate the second image 5 by reflecting the first characteristic amount 4. In short, the image adjusting unit 6 is a block which is assigned to generate the adjusted second image 7 whose luminance and chrominance have been adjusted based on the first characteristic amount 4.

Moreover, the image adjusting unit 6 may adjust or generate the second image 5 using the first characteristic amount 4 of the past frame.

Next, the generating unit 8 is explained.

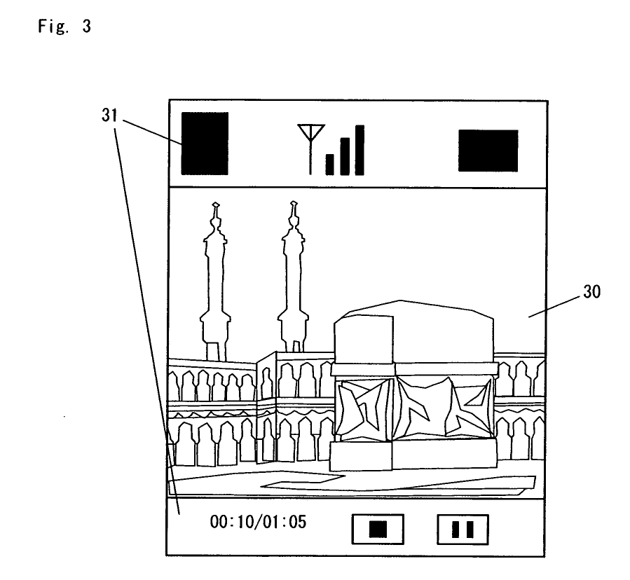

The generating unit 8 composes the adjusted second image 7 and the first image 2, and generates the display image 9. For example, the generating unit 8 superimposes the second image 5, which consists mainly of a graphics image, on the first image 2, which consists mainly of a natural image. As shown in FIG. 3, a display image 9 such as a picture-on-picture is generated. In addition to the natural image 30, letters and figure information 31 are displayed all together, thus responding to a user's convenience. FIG. 3 is an illustration showing the display image in Embodiment 1 of the present invention.

The generating unit 8 outputs the generated display image 9 to the second calculating unit 10 and the display adjusting unit 12.

In FIG. 1, although the generating unit 8 generates the display image 9 based on two kinds of images, the first image 2 and the second image 5, the generating unit 8 may generate the display image 9 based on more than two kinds of images.

The generating unit 8 generates the composed image of the first image and the adjusted second image 7 that is adjusted based on the first characteristic amount 4. The first characteristic amount is calculated from the first image 2 consisting of a natural image. Thus, the difference in the luminance and chrominance between the first image 2 and the adjusted second image 7 is small, in comparison with the difference in those between the first image 2 and the second image 5 before the adjustment. Accordingly, control of the light source described later becomes easier to be effective for the generated display image 9.

Next, the second calculating unit 10 is explained.

The second calculating unit 10 calculates the second characteristic amount 11 indicating a characteristic of the display image 9. Here, the second calculating unit 10 calculates luminance, chrominance, etc. of the display image 9 as the second characteristic amount 11.

At this time, an average value of the luminance and chrominance for one frame of the display image 9 or a maximum value of the luminance and chrominance in pixel units is calculated as the second characteristic amount 11. Alternatively, when the display image 9 is of RGB data, the average and maximum values of each of RGB components are calculated as the second characteristic amount 11. The second characteristic amount 11 calculated by the second calculating unit 10 is outputted to the display adjusting unit 12. Similar to the processing performed by the limiting unit 14 included in the image adjusting unit 6, it is also suitable to apply a limit to adjustment such that the difference of the second characteristic amount 11 calculated for every frame does not become too large.

In addition, although the second calculating unit 10 calculates the second characteristic amount 11 from one frame of the display image 9, the second calculating unit 10 may calculate it from several frames of the display image 9.

The second calculating unit 10 may calculate the second characteristic amount 11 from an arbitrarily chosen partial area of the display image 9. In this case, the partial area is chosen from an area where the second image 5 consisting of a graphics image (the adjusted second image 7) does not exist in the image display 9.

The reason that the partial area is chosen from an area where the second image 5 does not exist is because the main factor of the change in the luminance and chrominance of the entire display image 9 lies in an area consisting mainly of a natural image.

The second characteristic amount 11 calculated by the second calculating unit 10 is used as a reference of the adjustment in the display adjusting unit 12.

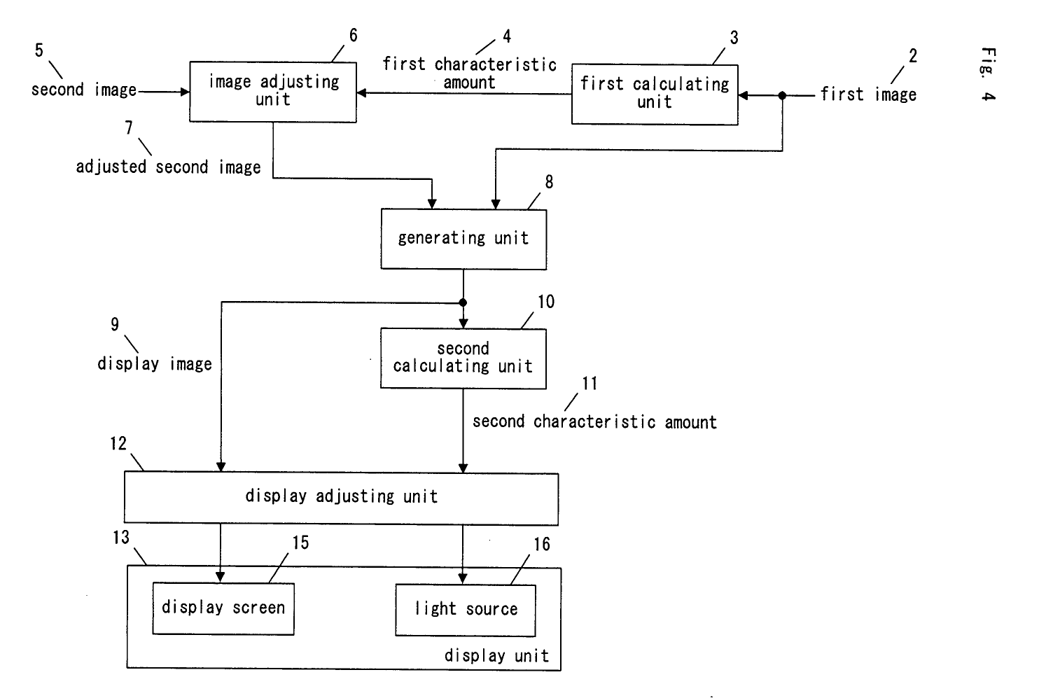

Next, the display adjusting unit 12 and the display unit 13 are explained referring to FIGS. 4 to 6.

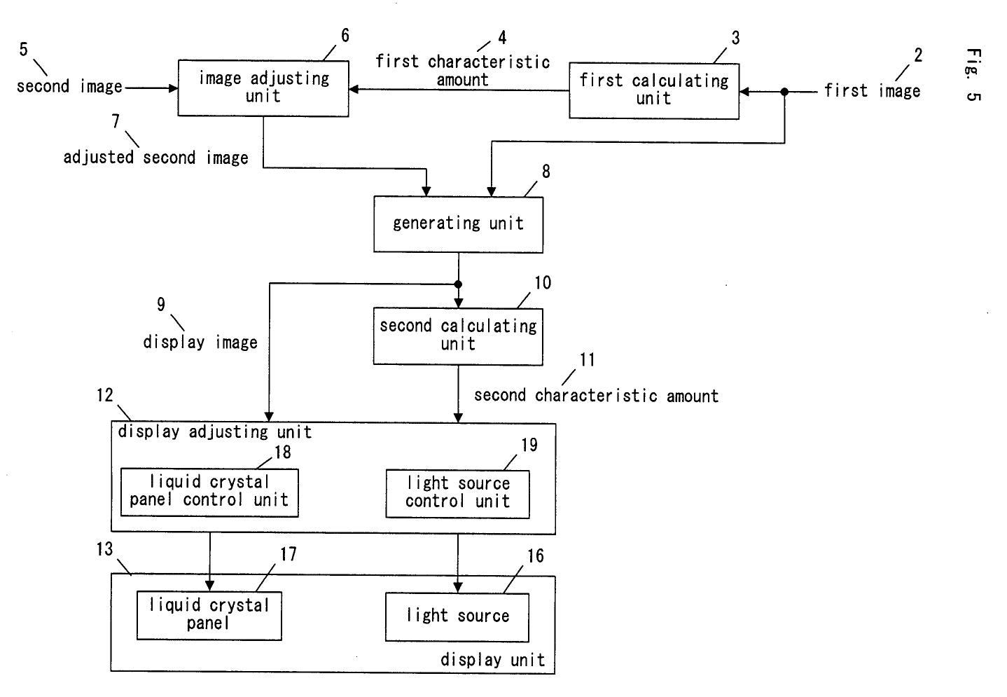

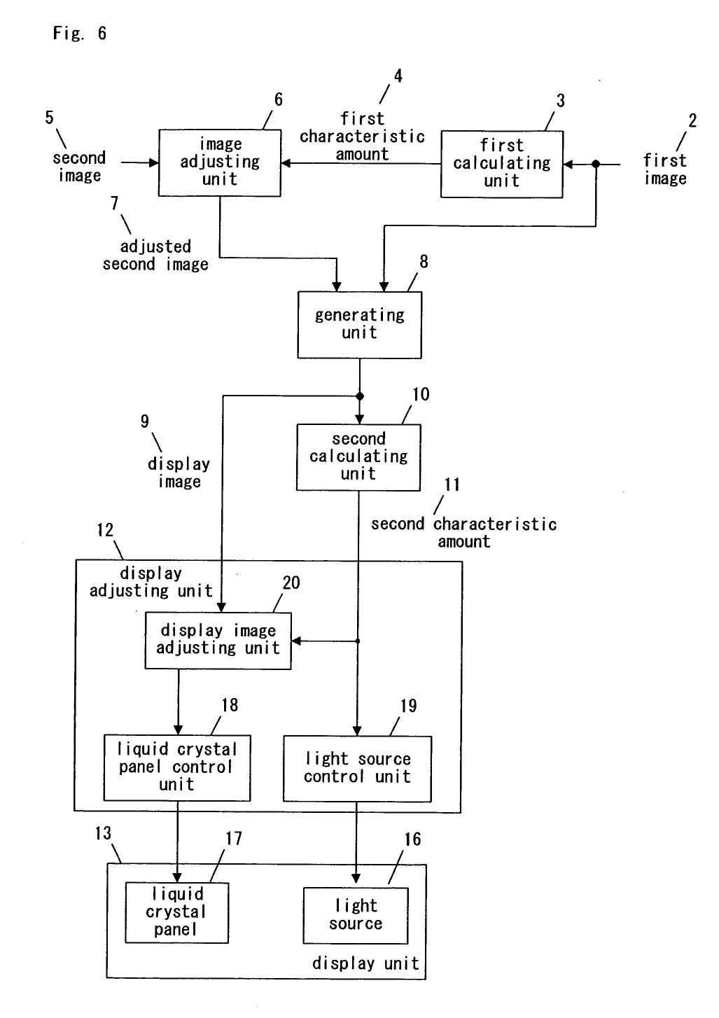

FIG. 4, FIG. 5 and FIG. 6 are block diagrams of the display control device in Embodiment 1 of the present invention.

The display adjusting unit 12 adjusts the display of the display image 9 on the display unit 13 based on the second characteristic amount 11. More specifically, when the second characteristic amount 11 calculated from the display image 9, that is generated by the generating unit 8, is based on the luminance, the display adjusting unit 12 adjusts the display of the display unit 13 such that the display becomes suitable for the luminance information included in the second characteristic amount 11.

In addition, the display adjusting unit 12 adjusts parameters such as luminance and chrominance of the display image 9 itself. In an alternative way, the display adjusting unit 12 adjusts the operation of the display unit 13 as a device, thereby realizing a display corresponding to the second characteristic amount 11.

Processing of the display adjusting unit 12 is explained referring to FIGS. 4 to 6.

As shown in FIG. 4, when the display unit 13 possesses a display screen 15 and a light source 16 which irradiates light at the display screen 15, the display adjusting unit 12 adjusts the display screen 15 and the light source 16, maintaining a relationship between them. For example, when the second characteristic amount 11 uses luminance as a parameter and the display adjusting unit 12 adjusts the luminance of the display adjusting unit 12, both of the display screen 15 and the light source 16 determine the final luminance of the display image 9 that is shown on the display unit 13. In other words, the luminance of the display image 9 shown on the display unit 13 is determined by the product of a parameter relating to the luminance of the display screen 15 and light intensity of the light source 16. The display adjusting unit 12 adjusts the luminance parameter of the display screen 15 and the light intensity of the light source 16, maintaining the relationship between them (since the final luminance of the display image 9 is determined by the product of the luminance parameter of the display screen 15 and the light intensity of the light source 16).

A case where the display unit 13 is a liquid crystal device is explained referring to FIG. 5. Such a liquid crystal device is often used for the display of a cellular phone and a portable terminal in recent years.

The display unit 13 comprises a liquid crystal panel 17 and a light source 16 which irradiates light at the liquid crystal panel 17. A back light is used for the light source 16. The light intensity of the back light determines the luminance of the display image 9. Similarly, the liquid crystal panel 17 determines the luminance of the display image 9 according to the magnitude of the transmittivity.

The display adjusting unit 12 adjusts the light intensity of the light source 16 and the transmittivity of the liquid crystal panel 17 based on the second characteristic amount 11. Here, the display adjusting unit 12 further comprises a liquid crystal panel control unit 18 and a light source control unit 19. The liquid crystal panel control unit 18 adjusts the transmittivity of the liquid crystal panel 17 using data included in the display image 9 and luminance information included in the second characteristic amount 11. Similarly, the light source control unit 19 adjusts the light intensity of the light source 16 using the second characteristic amount 11.

The luminance of the display image 9 shown on the display unit 13 is determined by the product of the adjusted transmittivity of the liquid crystal panel 17 and the adjusted light intensity of the light source 16.

For example, when the information indicating that the luminance is low is included in the second characteristic amount 11, the light source control unit 19 adjusts the light intensity of the light source 16 to a reduced level. Similarly, the liquid crystal panel control unit 18 adjusts the transmittivity of the liquid crystal panel 17 to a reduced level. On the contrary, when information indicating that the luminance is middle is included in the second characteristic amount 11, the light source control unit 19 adjusts the light intensity of the light source 16 to a middle level and the liquid crystal panel control unit 18 adjusts the transmittivity of the liquid crystal panel 17 to a middle level. Alternatively, the light source control unit 19 adjusts the light intensity of the light source 16 to a reduced level, while the liquid crystal panel control unit 18 adjusts the transmittivity of the liquid crystal panel 17 to an increased level. Further alternatively, the light source control unit 19 adjusts the light intensity of the light source 16 to an increased level, while the liquid crystal panel control unit 18 adjusts the transmittivity of the liquid crystal panel 17 to a reduced level. In any case, since the luminance of the display image 9 displayed on the display unit 13 is determined by the product of the transmittivity of the liquid crystal panel 17 and the light intensity of the light source 16, the display adjusting unit 12 adjusts them while maintaining a relationship between the liquid crystal panel 17 and the light source 16. In addition, in the adjustment with the relationship, the adjustment of the liquid crystal panel 17 and the light source 16 does not need to be synchronized thoroughly and a time lag may occur in the mutual adjustment.

As shown in FIG. 6, the display adjusting unit 12 may further comprise a display image adjusting unit 20 that adjusts the image quality of the display image 9. The display image adjusting unit 20 adjusts the luminance and contrast of the display image 9 based on the second characteristic amount 11. The luminance and contrast of the display image 9 is adjusted in order to suppress the change of the image quality by appearance, the change being caused by the adjustment of the liquid crystal panel 17 and the light source 16.

In any case, the display adjusting unit 12 adjusts the display of the display image 9 displayed on the display unit 13.

Since the second image 5 having an extremely high luminance is adjusted according to the luminance of the first image 2, the value of the luminance, which is calculated as the second characteristic amount 11, has enough room to the limit value of the luminance. Therefore, the display adjusting unit 12 has enough room in the luminance adjustment. Comparing to the prior art, the final luminance of the display image 9, which is displayed on the display unit 13, can be adjusted with a margin wide enough. This advantage is similarly enjoyed when the reference of the adjustment is chrominance.

Moreover, since the adjusted second image 7 is used for generating the display image 9, the difference in the luminance and chrominance between the natural image part and graphics image part of the display image 9 is reduced.

Next, an example of how the display control device 1 is operated is explained referring to FIG. 6.

The first image 2, which is a natural image, is inputted to the first calculating unit 3. The first calculating unit 3 calculates the maximum luminance of the first image 2 in pixel units as the first characteristic amount 4.

The image adjusting unit 6 adjusts the luminance of the second image 5, which is a graphics image, based on the first characteristic amount 4 having the maximum luminance of the first image 2 as information. At this time, the maximum luminance of the second image 5 is adjusted to the same as the maximum luminance of the first image 2.

For example, when the luminance is expressed by 8-bit-data, it is assumed that the value of the maximum luminance (information included in first characteristic amount 4) of the first image 2 is “128”, and the value of the maximum luminance of the second image 5 is “255.” In the case, the image adjusting unit 6 adjusts the maximum luminance of the second image 5 so that the maximum luminance of the second image 5 match “128”, which is the value of the maximum luminance of the first image 2. As a result, both values of the maximum luminance of the second image 5 and the maximum luminance of the first image 2 are same as the value of “128.”

Consequently, the difference of the luminance between the first image 2 and the second image 5 becomes smaller. Furthermore, when the reference is assumed to be the absolute maximum value “255” of the luminance, enough room for luminance adjustment remains, since the value of the maximum luminance of the first image 2 and the second image 5 after adjustment is “128”. Thus, in the display image 9 generated by the generating unit 8, the luminance difference between the graphics image part and the natural image part becomes smaller. The display adjusting unit 12 can also adjust, with a large margin, the luminance of the display image 9 or the display unit 13.

The generating unit 8 composes the first image 2 and the adjusted second image 7 for which the luminance is adjusted to the value of “128”, and generates the display image 9.

The second calculating unit 10 calculates the maximum luminance of the display image 9, and outputs it as the second characteristic amount 11. At this time, the value of the maximum luminance of the display image 9 is “128”, and this value is outputted as the second characteristic amount 11.

The display image adjusting unit 20 adjusts the contrast, brightness and so on of the display image 9 based on the value of the maximum luminance included in the second characteristic amount 11.

Furthermore, the liquid crystal panel control unit 18 adjusts the transmittivity of the liquid crystal panel 17 and the light source control unit 19 adjusts the light intensity of the light source 16, respectively, according to the value of “128”, which is the value of the maximum luminance included in the second characteristic amount 11. Since the value of the maximum luminance included in the second characteristic amount 11 is “128”, the light source control unit 19 adjusts the light intensity of the light source 16 to a level of 100% and the liquid crystal panel control unit 18 adjusts the transmittivity of the liquid crystal panel 17 to a level of 50%. Alternatively, the light control unit 19 adjusts the light intensity of the light source 16 to a level of 50%, while the liquid crystal panel control unit 18 adjusts the transmittivity of the liquid crystal panel 17 to a level of 100%.

According to the above adjustment, the display on the display unit 13 corresponding to the maximum luminance of the display image 9 is realized. In addition, since desirable luminance of the display image 9 is realized by adjusting the liquid crystal panel 17 and the light source 16 while maintaining the relationship between them, extra power consumption is reduced.

The light source 16 is adjusted in correspondence with the luminance of the display image 9 after adjusting the luminance of the second image 5 to the luminance of the first image 2. Thereby, power consumption in the light source 16, which usually consumes a lot of power, is reduced. Resultantly, power consumption in an electric device to which the display unit 13 is installed is reduced effectively.

The above-mentioned control is one of the examples. Instead of the maximum luminance, average luminance may be used for the first characteristic amount 4 or the second characteristic amount 11. Moreover, the second image 5 may be adjusted so as to match the maximum luminance or the average luminance of the first image 2 as in the above examples. Alternatively, the second image 5 may be adjusted so as to match an arbitrary value of the maximum luminance or the average luminance, the arbitrary value being determined at a predetermined difference with the first image 2.

In addition, the display control in Embodiment 1 may be installed as a hardware device, or may be installed as a software device.

In other words, a method and/or a device that performs the following steps is encompassed in the present invention: a calculating step that calculates the first characteristic amount 4 indicating the characteristic of the first image 2, a generating step that adjusts the second image 5 based on the first characteristic amount 4 and generates the adjusted second image 7, a generating step that composes the first image 2 and the adjusted second image 7 to generate the display image 9, a calculating step that calculates the second characteristic amount 11 indicating the characteristic of the display image 9, and an adjusting step that adjusts the display of the display image 9 in the display unit 13 based on the second characteristic amount 11.

As mentioned above, according to the display control device and the display control method of the present invention, the display pleasant to viewers can be shown on the display screen and wasteful power consumption by the display device can be reduced.

### Embodiment 2

Next, Embodiment 2 is explained.

In Embodiment 2, an embodiment of circuit scale reduction of the display control device 1 is explained.

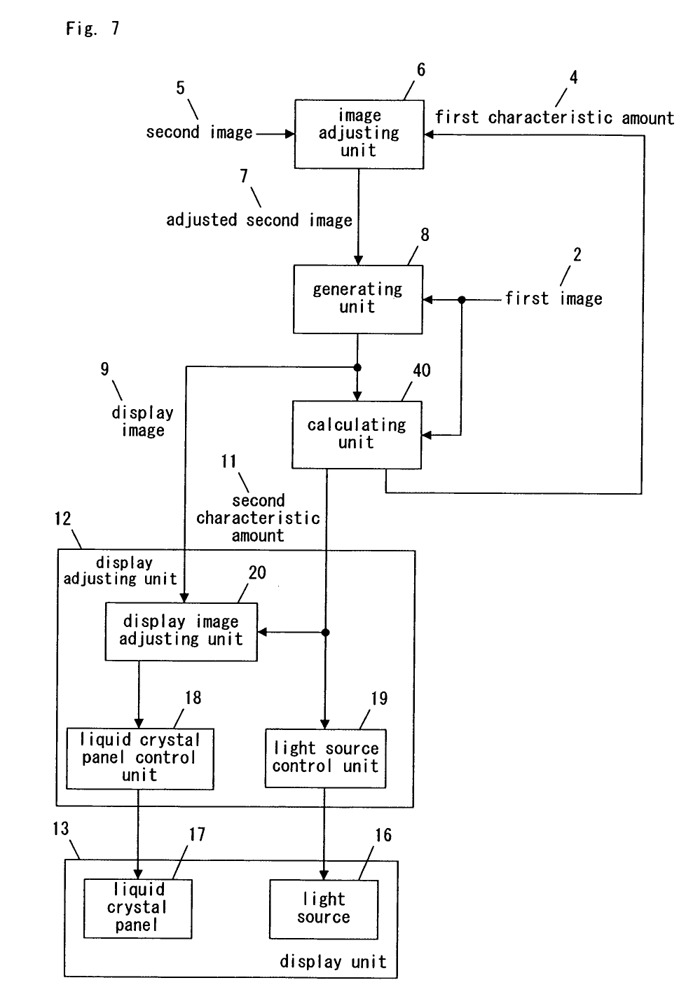

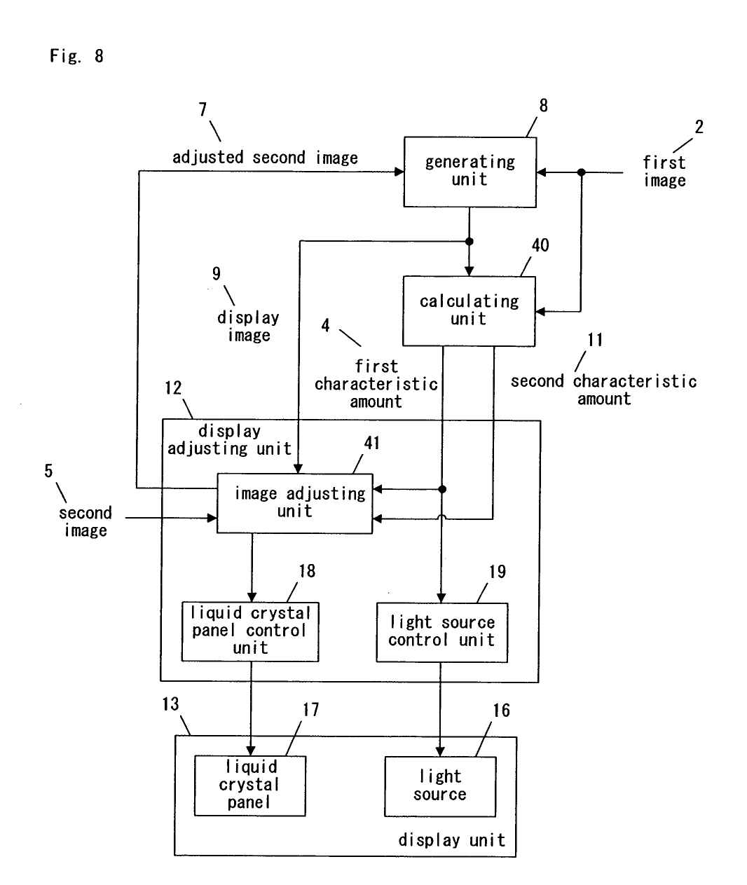

FIG. 7 and FIG. 8 are block diagrams of the display control device in Embodiment 2 of the present invention. First, FIG. 7 is explained.

In the display control device 1 shown in FIG. 7, the first calculating unit 3 and the second calculating unit 10, which are included in the display control device 1 shown in FIGS. 1 and 2 etc., are communalized as a calculating unit 40. Since the first calculating unit 3 and the second calculating unit 10 perform the same processing that calculates the characteristic amount (luminance, chrominance, etc.) of respective image, they can share one calculating unit 40.

The calculating unit 40 receives the first image 2 and the display image 9, calculates the first characteristic amount 4 from the first image 2, and the second characteristic amount 11 from the display image 9. The first characteristic amount 4 and the second characteristic amount 11 to be calculated are the same as described in Embodiment 1, such as luminance, chrominance, and RGB components. The calculating unit 40 performs the same calculation process in calculating the first characteristic amount 4 and the second characteristic amount 11.

The calculated first characteristic amount 4 is outputted to the image adjusting unit 6. The image adjusting unit 6 adjusts the second image 5 based on the first characteristic amount 4. For example, when the first characteristic amount 4 shows the maximum luminance of the first image 2, the maximum luminance of the second image 5 is adjusted so as to match the maximum luminance of the first image 2. After the image adjusting unit 6 performs adjustment, the image adjusting unit 6 outputs the adjusted second image 7 to the generating unit 8.

In this way, by making the luminance of the second image 5 consisting of the graphics image with the high luminance match the luminance of the first image 2 consisting of the natural image, the maximum luminance of the display image 9 finally shown is suppressed. As a result, the power consumption of the display unit 13, which increases with the increased luminance, decreases effectively. (When the luminance is high, the light intensity of the light source 16 is also high, accompanied by the increased power consumption in the light source 16.)

The generating unit 8 composes the first image 2 and the adjusted second image 7, and generates the display image 9 to be outputted to the calculating unit 40.

The calculating unit 40 calculates the second characteristic amount 11 from the display image 9 and outputs the calculated second characteristic amount 11. The calculating unit 40 calculates the first characteristic amount 4 and the second characteristic amount 11 in time sharing.

For example, it is assumed that an arbitrary input frame is eventually displayed on the display unit 13 after a certain amount of processing time. In time sharing, the calculating unit 40 completes calculation of the first characteristic amount 4 from the second image 5 before adjustment, within the first half of the processing time. Then, the calculating unit 40 performs calculation of the second characteristic amount 11 from the display image 9, which is generated using the adjusted second image 7, within the second half of the processing time.

As a result, during the processing time that is necessary for inputting and displaying one frame, the calculation of the first characteristic amount 4 and the calculation of the second characteristic amount 11 are processed in time sharing. In other words, the first calculating unit 3 and the second calculating unit 10 shown in FIG. 1 and FIG. 2 etc. can be constituted by the common calculating unit 40.

Moreover, as shown in FIG. 8, it is also suitable that the image adjusting unit 6 and the display image adjusting unit 20 are communalized by an image adjusting unit 41 in addition to the calculating unit 40.

The image adjusting unit 41 adjusts the display image 9 based on the second characteristic amount 11, while adjusting the second image 5 based on the first characteristic amount 4. Since the image is adjusted based on the characteristics such as luminance and chrominance, the image adjusting unit 6 and the display image adjusting unit 20 can be communalized.

The image adjusting unit 41 performs adjustment of the second image 5 and adjustment of the display image 9 in time sharing as in the calculating unit 40. For example, the image adjusting unit 41 adjusts the second image 5 using the first half of the processing time that is necessary from inputting to displaying of a frame, and adjusts the display image 9 using the second half of the processing time.

As mentioned above, since the first calculating unit 3 and the second calculating unit 10 are communalized by the calculating unit 40 and the image adjusting unit 6 and the display image adjusting unit 20 are communalized by the image adjusting unit 41, circuit scales can be reduced. Especially, when the display control device 1 is composed of IC, LSI and so on, the effectiveness of the circuit scale reduction and the accompanying power consumption reduction are realized.

The adjustment of the display unit 13 by the display adjusting unit 12 in the present embodiment is the same as that of Embodiment 1 explained earlier.

The display screen and the light source are adjusted based on the second characteristic amount 11 and the display image 9. Since the luminance of the second image 5 with high luminance is lowered so as to match the first image 2, an enough margin for display adjustment is obtained. Thus, the display image 9 displayed on the display unit 13 is adjusted appropriately. Moreover, since the display based on unnecessarily high luminance is avoided, the light intensity of the light source 16 is reduced and the power consumption is also reduced.

As for the image composed in the generating unit 8, a third image other than the first image 2 and the second image 5 may be added. In that case, the first characteristic amount 4 may be calculated from the third image or from the first and third images together, instead of from the first image 2.

According to the present invention, artificially generated graphics images are composed with a natural image to generate the display image 9, after appropriate adjustment is performed on the graphics images, based on the characteristic amount of the natural image having natural changes in luminance and chrominance. Large difference in the luminance and chrominance between the natural image part and the graphics image part is suppressed, leading to an easier control of the display image by the light source.

Since the extremely high luminance of the graphics image is adjusted closer to the usual luminance of the natural image, enough room remains in adjusting the luminance within the maximum value of the luminance, and the degree of freedom in the luminance adjustment of the display image 9 increases. As a result, the luminance adjustment of the display image 9 becomes appropriate and easier. The power consumption can be reduced at the same time.

Since the maximum luminance of the display image 9 to be generated is suppressed lower than the unnecessarily high luminance that the graphics image possesses at the beginning, the maximum value of the luminance in the display unit 13 becomes lower. Thus, the light intensity of the light source 16 included in the display unit 13 is also suppressed, and the power consumption is reduced. The display image 9 is adjusted most suitably by adjusting the display screen 15 and the light source 16 with a relationship between them.

Moreover, a gap between the frames decreases and the display image 9, which is pleasant for viewers, is displayed by limiting appropriately the adjustment amount in adjustment of the graphics image.

By sharing circuit blocks such as used for calculation of the characteristic amount and for adjustment of the image, the circuit scale of the display control device 1 is reduced, and miniaturization of devices and circuits, and accompanying reduced power consumption can be realized. Processing, operation, and elements used for the processing explained in Embodiments 1 and 2 are one of the examples.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A display control device comprising:
a first calculating unit operable to calculate a first characteristic amount characterizing a first image;
an image adjusting unit operable to adjust a second image according to the first characteristic amount, thereby generating an adjusted second image;
a generating unit operable to generate a display image to be displayed on a display unit, by composing the first image and the adjusted second image;
a second calculating unit operable to calculate a second characteristic amount characterizing the display image; and
a display adjusting unit operable to adjust, according to the second characteristic amount, appearance of the display image displayed on the display unit.

2. The display control device as claimed in claim 1, wherein the first image is a natural image and the second image is a graphics image.

3. The display control device as claimed in claim 1, wherein said first calculating unit calculates, as the first characteristic amount, at least one of luminance and chrominance of the first image.

4. The display control device as claimed in claim 1, wherein said image adjusting unit adjusts at least one of luminance and chrominance of the second image.

5. The display control device as claimed in claim 1, wherein said image adjusting unit further comprises:
a limiting unit operable to limit an adjustment amount in adjusting the second image.

6. The display control device as claimed in claim 5, wherein said limiting unit limits the adjustment amount to a certain greatest amount.

7. The display control device as claimed in claim 5, wherein said limiting unit limits the adjustment amount for a present picture frame which is an adjusting target for said image adjusting unit, in such a manner that a difference between the adjustment amount for the present picture frame and an adjustment amount for a picture frame previous to the present picture frame is less than a predetermined amount.

8. The display control device as claimed in claim 1, wherein said second calculating unit calculates at least one of luminance and chrominance of the display image.

9. The display control device as claimed in claim 1, wherein said second calculating unit calculates the second characteristic amount from a partial area arbitrarily chosen in the display image.

10. The display control device as claimed in claim 9, wherein the partial area is an area where the second image does not exist in the display image.

11. The display control device as claimed in claim 1, wherein said display adjusting unit adjusts a display screen and a light source, keeping relationship therebetween, the display screen and the light source being included in the display unit.

12. The display control device as claimed in claim 11, wherein said display adjusting unit adjusts luminance of the display image displayed on the display screen and luminance of the light source, keeping the relationship between the luminance of the display image and the luminance of the light source.

13. The display control device as claimed in claim 11, wherein the display screen is a liquid crystal panel, and said display adjusting unit adjusts transmittivity of the liquid crystal panel and the luminance of the light source.

14. The display control device as claimed in claim 1, wherein said first calculating unit and said second calculating unit use a common calculating unit in a time-sharing manner.

15. A display control device comprising:
a generating unit operable to generate a display image to be displayed on a display unit, by composing a first image and an adjusted second image;
a calculating unit operable to calculate a first characteristic amount characterizing the first image and a second characteristic amount characterizing the display image;
an image adjusting unit operable to adjust a second image according to the first characteristic amount, thereby generating the adjusted second image; and
a display adjusting unit operable to adjust, according to the second characteristic amount, appearance of the display image displayed on the display unit.

16. A display control method comprising:
performing first calculation to calculate a first characteristic amount characterizing a first image;
performing image adjustment to adjust a second image according to the first characteristic amount to generate an adjusted second image;
generating a display image to be displayed on a display unit, by composing the first image and the adjusted second image;
performing second calculation to calculate a second characteristic amount characterizing the display image; and
performing display adjustment to adjust, according to the second characteristic amount, appearance of the display image displayed on the display unit.

17. The display control method as claimed in claim 16, wherein said performing the first calculation calculates, as the first characteristic amount, at least one of luminance and chrominance of the first image, and
wherein said performing the image adjustment adjusts at least one of luminance and chrominance of the second image.

18. The display control method as claimed in claim 16, wherein said performing the image adjustment further comprises:
limiting an adjustment amount in adjusting the second image.

19. The display control method as claimed in claim 16, wherein said performing the second calculation calculates the second characteristic amount from a partial area arbitrarily chosen in the display image.

20. The display control method as claimed in claim 16, wherein said performing the display adjustment adjusts a display screen and a light source, keeping relationship therebetween, the display screen and the light source being included in the display unit.
